(19) United States
(12) Patent Application Publication
(10) Pub. No.: US 2002/0112029 A1
(43) Pub. Date: Aug. 15, 2002

(54) SYSTEM AND METHOD FOR ACCEPTING AND INTEGRATING ENTERTAINMENT INFORMATION FROM ENTERTAINMENT INFORMATION PRODUCERS

(76) Inventor: CRAIG S. GRAVINA, SARATOGA SPRINGS, NY (US)

Correspondence Address: KENYON & KENYON, ONE BROADWAY, NEW YORK, NY, 10004, US

(21) Appl. No.: 09/035,774

(22) Filed: Mar. 6, 1998

(51) Int. Cl. G06F 15/177; G06F 15/16

(52) U.S. Cl. 709/219

(57) ABSTRACT

A system and method for modifying (adding, deleting and/or changing) entertainment information from a producer. A producer identifier is received, and an edit interface is provided to the producer. Edit information is received from the producer, and integrated into entertainment information. The edit interface can provide hyperlinks and areas for inputting edit information to modify entertainment information conveniently and efficiently.

### FIELD OF THE INVENTION

The field of the invention is accepting entertainment information over a network, and in particular to accepting entertainment information from entertainment information producers and integrating this information so that it can be provided to a consumer.

### BACKGROUND OF THE INVENTION

Known systems exist that provide entertainment information to a consumer. As used herein, the term “consumer” refers to any entity that seeks to access entertainment information in order to browse the information or decide what program to view. Entertainment information includes any information about entertainment programming, e.g., information about the content of entertainment programs, broadcast schedules, advertisements about entertainment programs, instructions on how to access entertainment programs on demand, etc.

In these known systems, entertainment information is gathered from a variety of sources, and integrated. As used herein, the term “entertainment producer” refers to the supplier of entertainment information. Examples of an entertainment producer include a television network, a cable network, an entertainment critic, a show producer, etc. The integrated entertainment information is then provided to the consumer, typically from a centralized source. As used herein, the term “entertainment server” refers to a source of integrated entertainment information which a consumer accesses in order to obtain entertainment information. An “entertainment information service provider” refers to an entity that operates an entertainment server to provide entertainment information to consumers. A known entertainment server is typically a single server or server farm that may be located at one or more network locations. This advantageously provides the consumer with a “one-stop shopping” place for entertainment information, a single place at which can be found a useful, broad range of entertainment information. Copies of the integrated information can be stored at several entertainment servers, so that consumers can access entertainment information that is stored nearby. This advantageously reduces latency (the time elapsed between a consumer request for information over the network and the time the consumer receives the requested information). This can also advantageously distribute the workload of responding to consumer requests for information over several server sites.

In known systems, the collection, integration and presentation of entertainment information to the consumer is governed by the entertainment information service provider, and any addition, deletion, or modification to entertainment information necessarily involves the intervention of the service provider. Hereinafter, the term “modify” is meant to encompass additions, deletions and changes to information. The intervention of the service provider between the producer of the information and the consumer can introduce errors and imperfections into the process of providing consumers with accurate and current entertainment information. Numerous editorial decisions are made by the service provider out-of-sight from the producer. On some occasions, information deemed essential by the producer is not presented, inaccurate information is added, and/or the producer's entertainment information is otherwise modified in a way that renders it inaccurate. The producer also disadvantageously has little control over the format and/or currency of the entertainment information made available by the service provider to the consumer. The intervention of the service provider in modifying and maintaining the currency of entertainment information also raises the cost of providing the information to the consumer. The intervention of the service provider in known systems can result in providing inaccurate, out-of-date entertainment information in a confusing fashion to the consumer. Further, there is no known mechanism for providing hyperlinks that link entertainment program material with online information resources.

A better system would allow the entertainment producer to exercise as much control as possible over what entertainment information within the producer's purview is provided to consumers by the service provider, as well as how it is presented. This would advantageously reduce the likelihood of inaccuracies in the entertainment information, improve its currency, reduce the cost of providing the information, and provide the information in a clear and pleasing way to the consumer. Further, a better system would provide a mechanism for linking entertainment program material such as television shows, movies and advertisements with online information resources such as official web sites, online chat groups and fan web sites.

### SUMMARY OF THE INVENTION

The present invention advantageously provides a system and method for modifying entertainment information by a producer without the direct human intervention of an entertainment service provider. The producer is thus advantageously enabled to better maintain its entertainment information, making it easier to provide accurate and current entertainment information to consumers more efficiently and at a lower overall cost.

In accordance with an embodiment of the present invention, a producer identifier is received. In one embodiment, the producer is authenticated. An edit interface is provided to the producer. Edit information is received from the producer using the edit interface, and this edit information is integrated into the entertainment information stored at the entertainment server. The entertainment information is adapted to be viewed by a consumer. It should be noted that the term “entertainment information stored at the server” means that the information is stored in a way that renders it accessible to the server. It need not be stored physically at the server itself. On the contrary, in one embodiment, the entertainment information is stored at a different location from the entertainment server, and is accessed by the server through the network.

The edit interface provides an easy-to-use means for the producer to access and modify (add, delete or change) entertainment information. In one embodiment, this is achieved using hyperlinks that identify different elements of entertainment information. When a producer selects a hyperlink that corresponds to entertainment information that the producer seeks to modify, then another element of the edit interface (e.g., an edit listings interface) is presented to the producer through which the producer can advantageously modify information pertaining to the selected hyperlink.

### BRIEF DESCRIPTION OF THE DRAWINGS

FIG. 1 shows an apparatus and system in accordance with the present invention.

FIG. 2 shows a flow chart that illustrates an embodiment of the method of the present invention.

FIG. 3 shows an embodiment of an element of an edit interface, a first embodiment of a listings grid, in accordance with the present invention.

FIG. 4 shows another embodiment of an element of an edit interface, a second embodiment of a listings grid, in accordance with the present invention.

FIG. 5 shows another embodiment of an element of an edit interface, a first embodiment of an edit listings interface, in accordance with the present invention.

FIG. 6 shows another embodiment of an element of an edit interface, a second embodiment of an edit listings interface, in accordance with the present invention.

### DETAILED DESCRIPTION

The present invention allows an entertainment information producer to modify (add, delete and/or change) entertainment information provided to consumers by an entertainment information service provider without the intervention of the service provider.

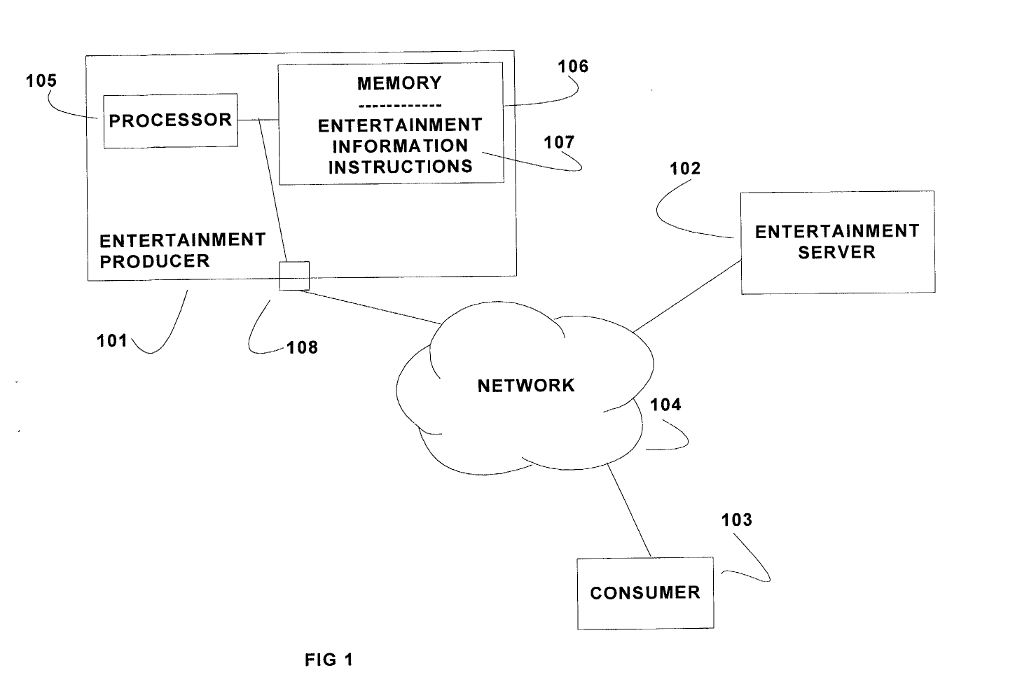

An apparatus and system in accordance with one embodiment of the present invention is shown in FIG. 1. An entertainment producer 101, an entertainment server 102 and a consumer 103 are coupled to a network 104. Entertainment server 102 provides entertainment information obtained at least partly from entertainment producer 101 to consumer 103. In one embodiment of the present invention, entertainment server 102 includes a processor 105 and a memory 106 that stores instructions 107 adapted to be executed by processor 105 to perform the steps of the method of the present invention. In one embodiment, instructions 107 are adapted to be executed by processor 105 to receiving a producer identifier from producer 101, provide an edit interface to producer 101, receive edit information from producer 101, and integrate the edit information received from producer 101 into entertainment information adapted to be viewed by consumer 103.

In various embodiments the present invention, memory 106 is a hard disk, read-only memory (e.g., a compact disk read-only memory), random access memory, flash memory or any combination thereof. Memory 106 is meant to encompass any medium capable of storing digital data.

In one embodiment, processor 105 is a general purpose microprocessor, such as the Pentium II microprocessor manufactured by the Intel Corporation of Santa Clara, Calif.

In another embodiment, processor 105 is an Application Specific Integrated Circuit that at least partly embodied instructions 107.

Instructions 107 are adapted to be executed on processor 105 to perform the method in accordance with the present invention. As used herein, the phrase “adapted to be executed” is meant to encompass instructions stored in a compressed and/or encrypted format, as well as instructions that have to be compiled or installed by an installer before being executed by processor 105.

In one embodiment, network 104 is the Internet, consumer 103 is a personal computer, and producer 101 is a server computer capable of hosting a web site on the World Wide Web (WWW).

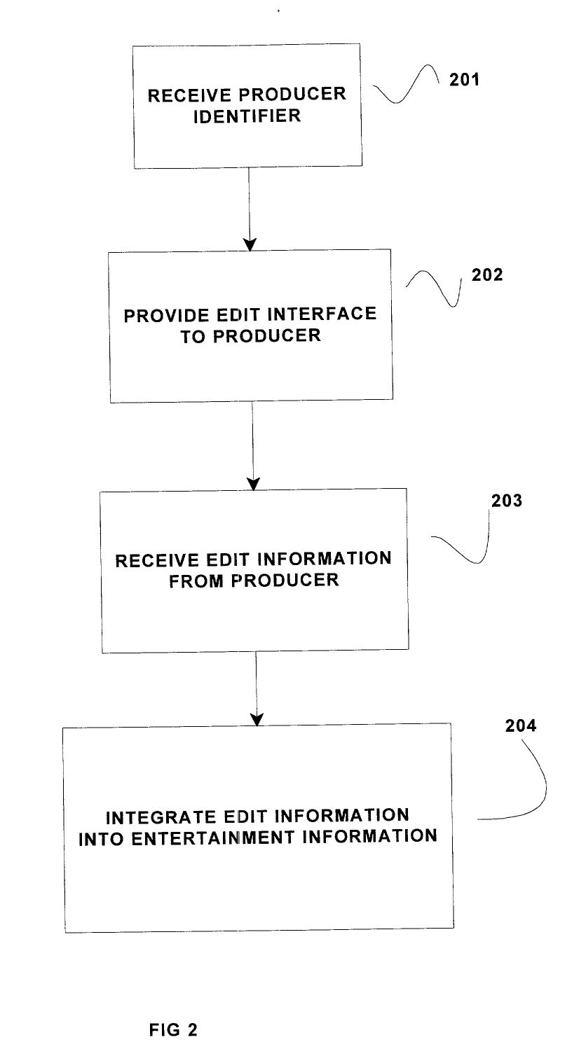

An embodiment of the method of the present invention is shown in FIG. 2. A producer identifier is received from a producer, step 201. In one embodiment, this step includes authenticating the producer. For example, in one embodiment, the producer is required to provide a secret password to verify that the producer is in fact who it purports to be. In another embodiment, cryptographic authentication techniques known in the art (e.g., public key encryption) are used to authenticate the producer. An edit interface is provided to the producer, step 202. The edit interface is the means by which the producer modifies (adds, deletes, changes) entertainment information stored at the entertainment server. Edit information provided by the producer through the edit interface is received, step 203, and then integrated into the entertainment information stored at the server, step 204. The integrated entertainment information is adapted to be viewed by a consumer.

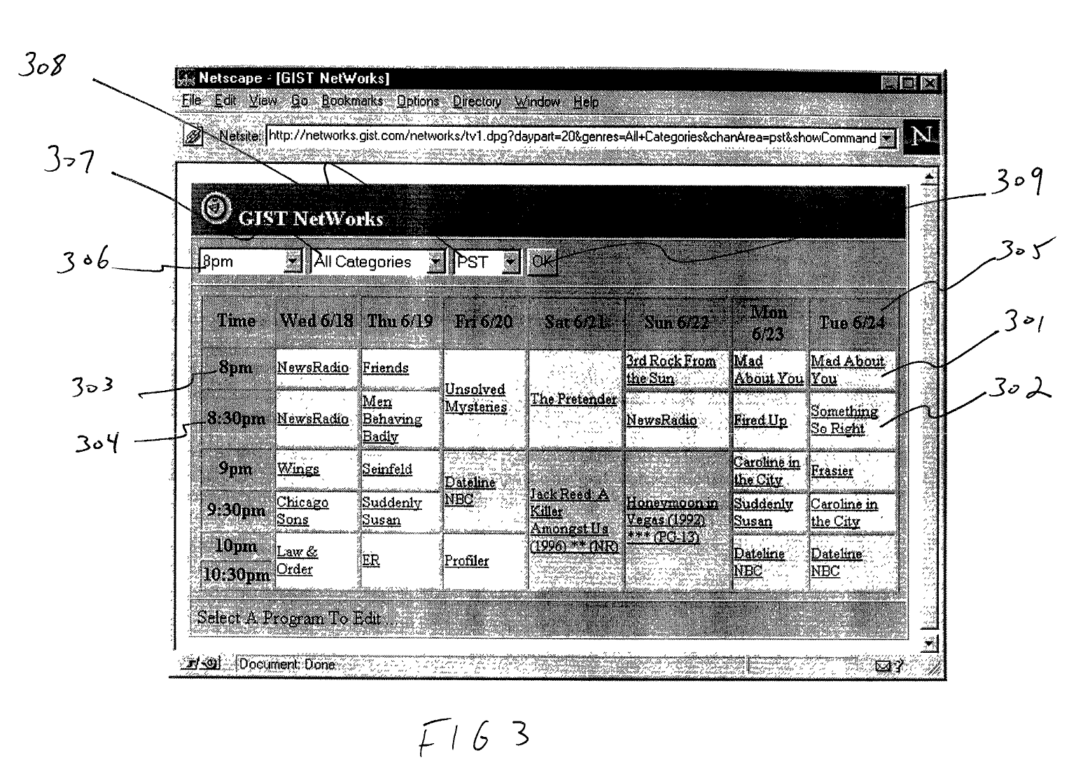

In one embodiment, the edit interface includes an listings grid shown in FIG. 3. The listings grid shows the producer a hyperlink to the present state of the entertainment information stored at the server. In one embodiment, the listings grid can be advantageously used to search the entertainment information to identify a subset of the information that the producer wishes to modify. FIG. 3 illustrates an embodiment of a listings grid that shows the names of entertainment programs, e.g., 301 and 302, the times at which they are scheduled to be shown, e.g., 303 and 304, and the dates on which they are to be shown, e.g., 305. The interface provides areas where the producer can input search criteria including time 306, categories 307 and time zone 308. When the producer selects the OK button 309, the entertainment server searches for entertainment information that at least approximately meets the criteria provided by the producer, and presents it in the listings grid interface.

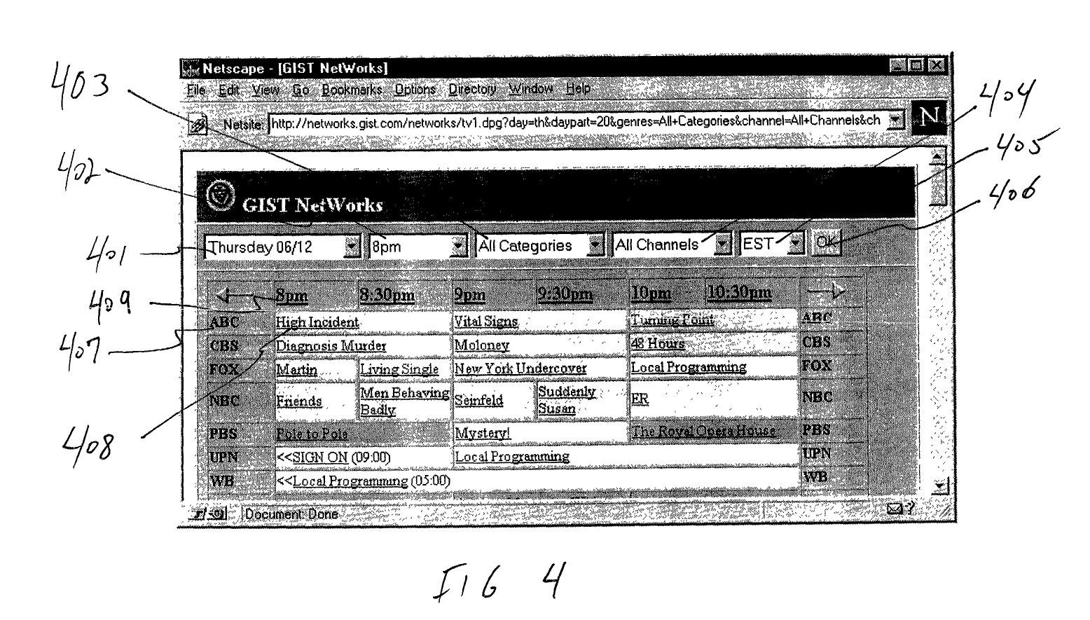

Another embodiment of the listings grid is shown in FIG. 4. This embodiment includes search criteria for the date 401, time 402, categories 403, channels 404 and time zone 405. When these criteria are supplied by the producer and the producer selects the OK button 406, then the server searches for and displays the appropriate entertainment information, including, for example, the network, e.g., 407 on which a program, e.g., 408 is shown and at what time, e.g, 409. In accordance with one embodiment of the present invention, the names of the programs shown in FIG. 3 (e.g., 301 and 302) and FIG. 4 (e.g., 408) are hyperlinks to other elements of the edit interface (e.g., an edit listings interface) through which entertainment information pertaining to the entertainment program corresponding to a selected link can be modified. In one embodiment, the edit interface is presented to the producer based upon the producer's selection of a listings grid hyperlink corresponding to a particular program. In another embodiment, the edit listings interface is presented directly to the producer without first presenting a listings grid.

In another embodiment of the present invention, other elements of entertainment information are presented as hyperlinks that can be modified by the producer. For example, in one embodiment of the present invention, an authorized producer can modify the date or time at which the entertainment information reflects a particular program is scheduled to be shown. In another embodiment, a producer can modify the channel on which a program is scheduled to be shown. Any element of entertainment information can be modified by an authorized producer in accordance with the present invention. The modifications discussed below are meant to be exemplary and illustrative, but not limiting.

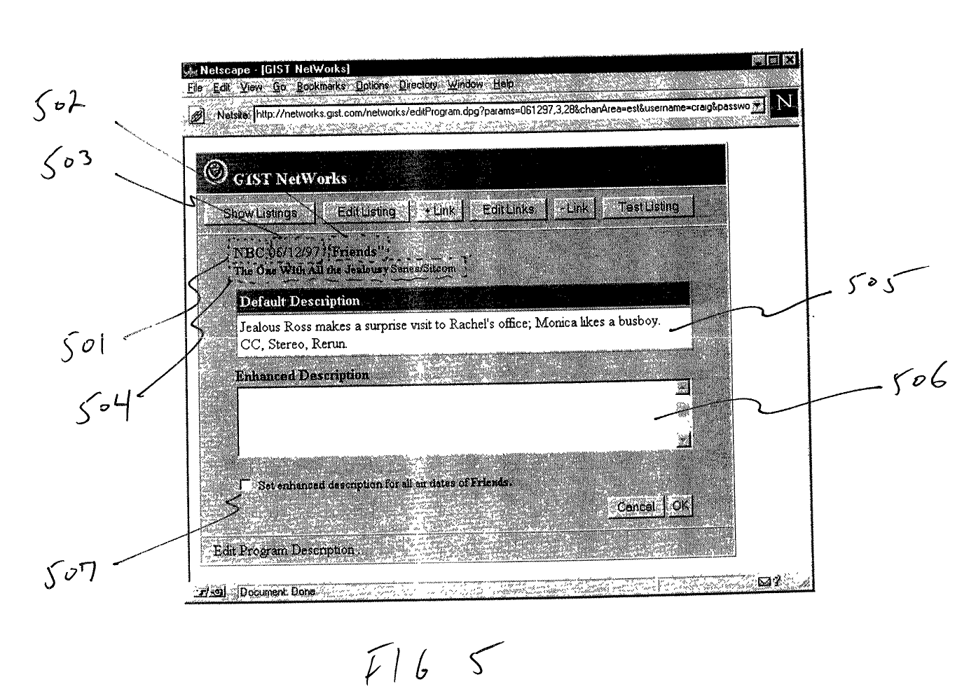

An embodiment of an edit listings interface through which a producer can modify the description of a particular program that is shown to a consumer is shown in FIG. 5. This embodiment of the edit interface identifies the network 501 on which the program 502 is shown the scheduled air date 503, the title of the episode 504, and the default description 505. In accordance with one embodiment of the present invention, the producer can edit the default description 505. In another embodiment, the producer can add enhanced description information 506 that will appear in place of the default description. The producer has the option of selecting the box “set enhanced description for all air dates” 507 of the particular program. This is appropriate for information that the producer desires to make available to consumers that pertains not only to the particular episode 504 of the program 502, but to the program 502 in general.

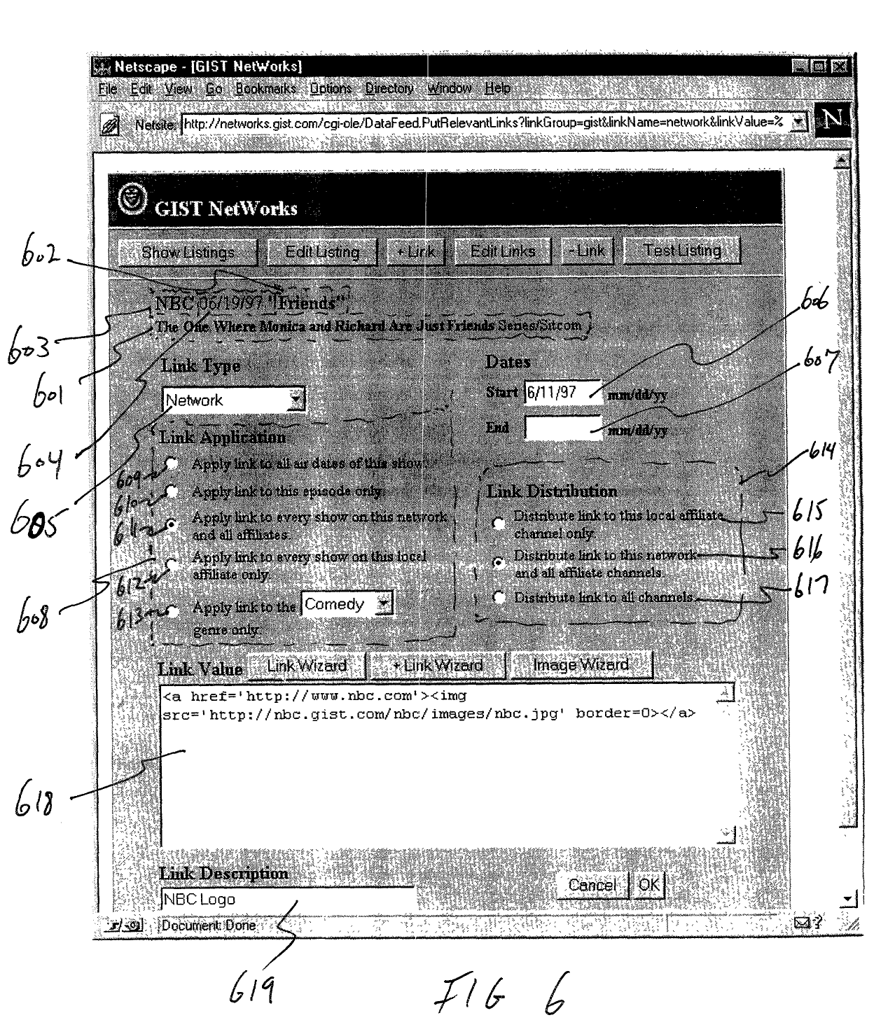

Another embodiment of an edit listings interface is shown in FIG. 6. This embodiment allows a producer to modify one or more hyperlinks contained in entertainment information adapted to be presented to a consumer. As shown in FIG. 6, the hyperlinks in this embodiment are those that are associated with a particular episode 601 of a particular program 602, scheduled to be aired on a network 603 on a particular date 604. Through this interface, the producer can modify the hyperlink type 605, establishing that a hyperlink corresponds to an official web site, fan site, news group, actor appearing in the entertainment program, image, event, headline, editorial, network, affiliate and/or category for the particular program. These hyperlink types are merely exemplary. The present invention permits the producer to modify any hyperlink type 605. Further, the producer can modify the date on which a hyperlink is adapted first be shown to a consumer 606 and the date on which a hyperlink is adapted to last be shown to a consumer 607.

Further in accordance with this embodiment, the producer can modify how the link is applied (the link application) 608. The link can be applied to all air dates of the particular program 609, to a particular episode of the particular program 610, to every program shown on by a particular affiliate 611, to a particular network and the network's affiliates 612, and to every program in a particular category 613.

Also in accordance with the embodiment shown in FIG. 6, the distribution of the link (link distribution) 614 can also be modified by the producer. The link can be distributed only to a particular local affiliate channel 615, to a particular network and its affiliates 616, and to all channels that show the particular program 617.

FIG. 6 also shows where a producer can modify (add, delete, change) the uniform resource locator of a hyperlink 618, and where the producer can modify the description of the link 619.

One embodiment of the present invention provides an edit interface that includes a hyperlink that links entertainment material (e.g., a television program name, network name, advertisement graphic, movie name, etc.) to online information resources corresponding to the entertainment material. For example, a hyperlink that appears as a graphic describing a television show, when selected, results in the display of information from another website about the actors that appear in the television show. Other types of online information resources include chat groups, fan web sites, advertiser web sites, etc.

Although several embodiments are specifically illustrated and described herein, it will be appreciated that modifications and variations of the present invention are covered by the above teachings and within the purview of the appended claims without departing from the spirit and intended scope of the invention.

What is claimed is:

1. A method for modifying entertainment information by a producer, including the steps of:
a. receiving a producer identifier;
b. providing an edit interface to the producer;
c. receiving edit information from the producer;
d. integrating the edit information received from the producer into the entertainment information.

2. The method of claim 1, wherein receiving a producer identifier includes the step of authenticating the producer.

3. The method of claim 1, wherein the edit interface includes a listings grid that shows entertainment information, and includes an entertainment information hyperlink that corresponds to entertainment information that can be modified by the producer.

4. The method of claim 3, wherein receiving edit information from the producer includes the step of receiving a listings grid entertainment information hyperlink selection from the producer.

5. The method of claim 3, wherein the entertainment information shown by the listings grid includes at least one type of entertainment information from the group of: a particular entertainment program name; a network name, a date on which an entertainment program is scheduled to be shown, a channel name, a time at which an entertainment program is scheduled to be shown, an entertainment program category, and a time zone.

6. The method of claim 3, wherein an entertainment information hyperlink pertains to at least one of the group of: a date, a time, a channel, a program name, a time slot and a channel lineup.

7. The method of claim 3, wherein receiving edit information from the producer includes the steps of receiving a listings grid entertainment information hyperlink selection from the producer and wherein providing an edit interface to the producer includes providing an edit listings interface through which the producer can modify entertainment information that corresponds to the selected entertainment information hyperlink.

8. The method of claim 7, wherein the selected entertainment information hyperlink corresponds to a particular entertainment program.

9. The method of claim 1, wherein providing an edit interface to the producer includes providing an edit listings interface through which the producer modifies entertainment information that corresponds to the particular entertainment program.

10. The method of claim 9, wherein the edit listings interface is used by the producer to modify at least one from the group of the name of the entertainment program; a time at which the entertainment program is scheduled to be shown, and a date on which the entertainment program is scheduled to be shown.

11. The method of claim 9, wherein the edit listings interface is used by the producer to modify information about the content of the entertainment program.

12. The method of claim 9, wherein the edit listings interface is used by the producer to modify at least one from the group of: a hyperlink type, the date on which a hyperlink is adapted first be shown to a consumer; the date on which a hyperlink is adapted to last be shown to a consumer; a link application; a link distribution; a link category; a link value; and a link description.

13. The method of claim 12, wherein the hyperlink type is one from the group of: official web site, fan site, news group, actor appearing in the entertainment program, image, event, headline, editorial, network, affiliate and category for the particular program.

14. The method of claim 12, wherein the link application is at least one from the group of: apply link to all air dates of the particular program, apply link to a particular episode of the particular program, apply link to every program shown on by a particular affiliate, apply hyperlink, to a particular network and the network's affiliates, and apply hyperlink to every program in a particular category.

15. The method of claim 12, wherein the link distribution is at least from the group of: distribute hyperlink only to a particular local affiliate that shows the particular program, distribute hyperlink to a particular network and particular network affiliates that show the particular program, and distribute link to all channels that show the particular program.

16. The method of claim 12, wherein the link value includes a uniform resource locator.

17. The method of claim 12, wherein the link value includes hypertext markup language.

18. The method of claim 12, wherein the link description is information pertaining to the content of information corresponding to a particular hyperlink.

19. The method of claim 9, wherein receiving edit information includes the step of receiving producer modifications to entertainment information through the edit listings interface.

20. An apparatus for modifying entertainment information by a producer, comprising:
a. a processor;
b. a memory that stores entertainment information instructions adapted to be executed by said processor to receive a producer identifier, provide an edit interface to the producer, receive edit information from the producer, integrating the edit information received from the producer into the entertainment information, said memory coupled to said processor; and
c. a port adapted to be coupled to a network, said port coupled to said processor and said memory.

21. The apparatus of claim 20, wherein the edit interface includes an edit listings interface.

22. The apparatus of claim 20, wherein said edit interface includes a listings grid.

23. A medium that stores instructions adapted to be executed by a processor to perform the steps of:
a. receiving a producer identifier;
b. providing an edit interface to the producer;
c. receiving edit information from the producer; and
d. integrating the edit information received from the producer into the entertainment information.

24. The medium of claim 23, wherein the edit interface includes an edit links interface.

25. The medium of claim 23, wherein the edit interface includes a listings grid.

26. A system for modifying entertainment information by a producer, comprising:
a. means for receiving a producer identifier;
b. means for providing an edit interface to the producer;
c. means for receiving edit information from the producer; and
d. means for integrating the edit information received from the producer into the entertainment information.

27. The method of claim 1, wherein an edit interface includes a hyperlink that links entertainment program material to an online information resource.
